(19) United States
(12) Patent Application Publication
(10) Pub. No.: US 2008/0278083 A1
(43) Pub. Date: Nov. 13, 2008

(54) Circuit Arrangement

(75) Inventor: Jozef Johannes Maria Hulshof, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,596

(22) PCT Filed: Jul. 24, 2006
(86) PCT No.: PCT/IB06/52526

§ 371 Date: Jan. 24, 2008

(30) Foreign Application Priority Data
Jul. 27, 2005 (EP) 05106887.2

(51) Int. Cl. H05B 41/28

(52) U.S. Cl. 315/194

(57) ABSTRACT

A ballast circuit receiving power from the mains and supplying a high frequency lamp current to a lamp is equipped with means to generate both a common mode current and a differential mode current through the mains supply terminals. Both these currents are phase shifted 180 degrees with respect to the lamp current. In this way currents induced in the mains supply terminals by means of parasitic capacitive coupling and magnetic coupling between conductors carrying the lamp current and the mains supply terminals are cancelled.

The invention relates to a circuit arrangement for supplying a lamp equipped with
input terminals for connection to a supply voltage source supplying a low frequency AC voltage,
a ballast circuit coupled to the input terminals for generating a high frequency lamp current with frequency f out of the low frequency AC voltage and equipped with lamp connection terminals.

Such a circuit arrangement is generally known and is for instance often used for operating discharge lamps. The high frequency lamp current ensures a comparatively high lamp efficacy. A disadvantage of the high frequency lamp current is that it induces high frequency currents in the supply voltage source. Two mechanisms can be discriminated. The first one is a capacitive coupling between conductors carrying the lamp current and the input terminals by means of parasitic capacitances. Although these parasitic capacitances are often smaller than 1 pF, at a frequency of more than 150 kHz their impedance is so low that a substantial amount of current is induced in the supply voltage source via the input terminals. The current through the input terminals caused by parasitic capacitances is a common mode current, meaning that the direction of the current is the same in both input terminals.

A second mechanism that causes high frequency disturbance is magnetic coupling. A conductor carrying a high frequency current generates a magnetic field of the same frequency and this magnetic field in turn induces electrical currents of the same frequency in electrical conductors that are situated in the magnetic field. Magnetic coupling between conductors carrying the lamp current and conductors connected to the input terminals causes a differential mode electric current of frequency f through the input terminals and the supply voltage source. In this case the induced current through one input terminal flows in a direction that is opposite to the direction of the induced current through the other input terminal.

In case the supply voltage is a mains supply, these currents cause disturbance called EMI. For many practical applications the maximum amount of disturbance allowed is given in a norm such as the EN55015 norm.

The invention aims to provide a circuit arrangement for operating a lamp at a high frequency in which the EMI generated by the lamp current is suppressed in an efficient way.

A circuit arrangement as mentioned in the opening paragraph is for that purpose characterized in that the circuit arrangement further comprises a circuit part DS coupled to the input terminals for generating a further high frequency current with frequency f through the input terminals, that is phase shifted with respect to the high frequency lamp current.

Since the further high frequency current is phase shifted with respect to the lamp current, it is generally also phase shifted with respect to the high frequency current induced by the lamp current. The phase shift between the induced current and the further high frequency current is chosen so that the induced current and the further high frequency current cancel each other at least to some extent so that the EMI caused by the lamp current is effectively suppressed. Optimal suppression is obtained in case the phase shift between the further high frequency current ad the induced current is approximately 180 degrees and the amplitudes of the two currents are approximately the same.

Since the phase shift between the lamp current and the induced current is often approximately zero, optimal suppression is generally obtained in case the further high frequency current is phase shifted with respect to the high frequency lamp current by half a period.

In case the induced current in the input terminals is caused by a capacitive coupling between the input terminals and one or more conductors carrying the high frequency lamp current, the induced current in the input terminals is a common mode current. As a consequence the further high frequency current generated by the circuit part DS needs to be a common mode current too. In this case a very effective and simple embodiment of the circuit part DS can be realized, wherein the circuit part DS comprises a PNP transistor of which a base electrode is coupled to a conductor that carries the lamp current during operation.

In case the induced current in the input terminals is caused by a magnetic coupling between one or more conductors carrying the lamp current and the input terminals, the induced current is a differential mode current. As a consequence, the further high frequency current needs to be a differential mode current as well. In this case the circuit part DS preferably comprises conductors connected between the input terminals and the ballast circuit and enclosing a first area and conductors connected between the ballast circuit and the lamp connection terminals and enclosing a second area and wherein the first and second area overlap. In this case, when the ballast circuit comprises a printed circuit board, an effective and cheap embodiment of the circuit part DS can be realized, wherein the circuit part DS comprises tracks of conductive material that during operation are magnetically coupled and are situated on opposing sides of the printed circuit board.

Embodiments of the invention will be further explained with reference to a drawing. In the drawings:

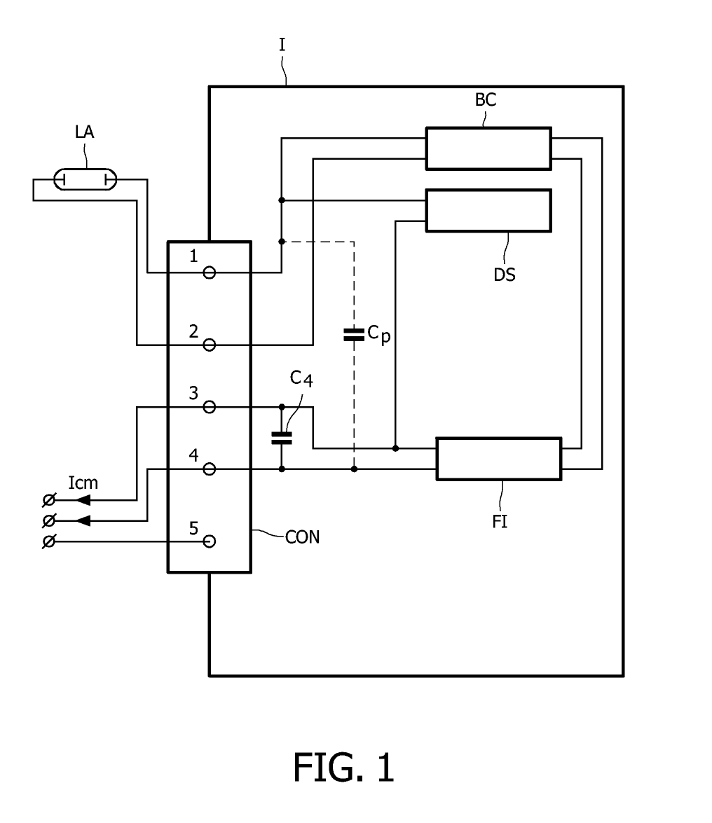

FIG. 1 shows a schematic representation of a first embodiment of a circuit arrangement according to the invention with a lamp connected to it;

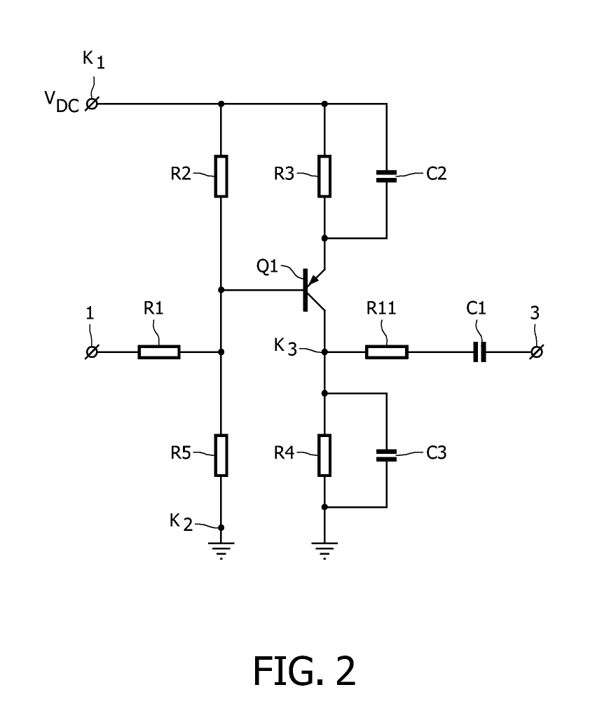

FIG. 2 shows a circuit part DS that is incorporated in the embodiment shown in FIG. 1 and is coupled to the input terminals;

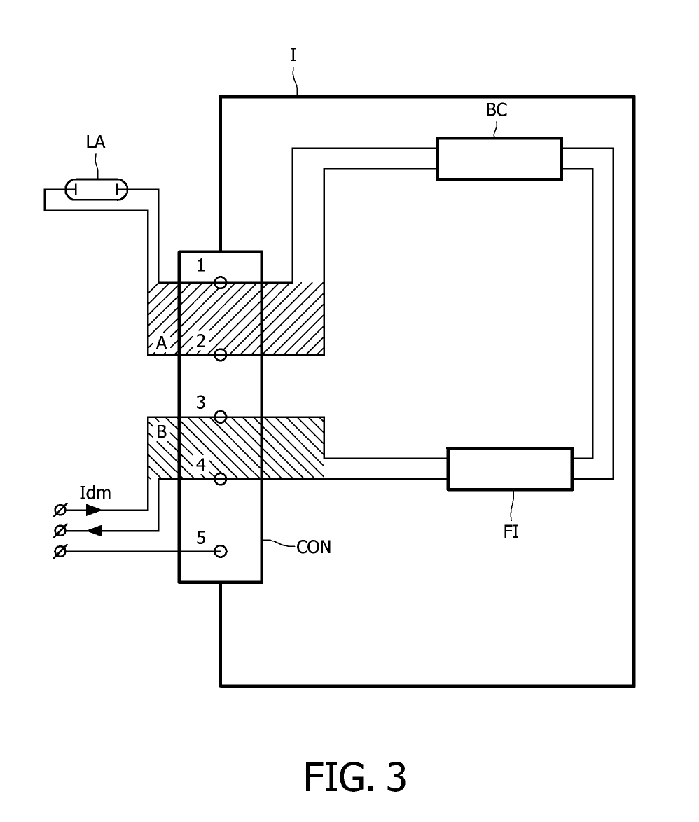

FIG. 3 shows a schematic representation of an embodiment of a prior art circuit arrangement for supplying a lamp; and

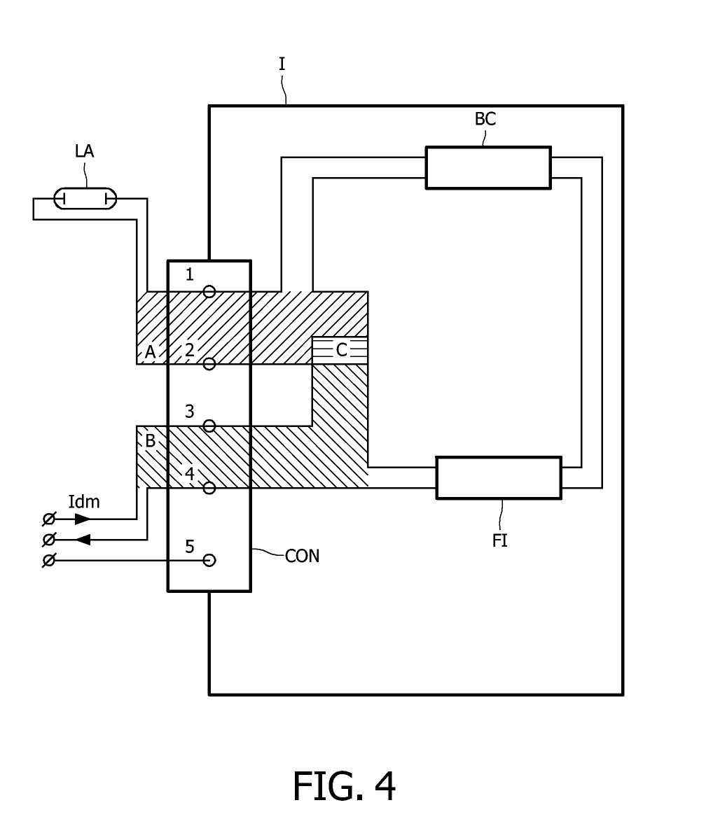

FIG. 4 shows a schematic representation of a second embodiment of a circuit arrangement for supplying a lamp according to the invention.

In FIG. 1, I is a circuit arrangement for supplying a lamp. CON is a connector. The connector is equipped with 5 connection terminals numbered 1-5. Connection terminals 1 and 2 are connected to a lamp LA. Connection terminal 3 is connected to the neutral pole of a supply voltage source supplying a low frequency AC voltage such as the mains voltage. Connection terminal 4 is connected to the other pole of the supply voltage source. Connection terminal 5 is connected to a protective earth. Since they are irrelevant to the invention, further connections of connection terminal 5 in the circuit arrangement I are not shown. Connection terminals 3 and 4 are connected to each other by means of a capacitor C4 and to respective input terminals of circuit part FI. Capacitor C4 and circuit part FI together form an input filter. Respective output terminals of circuit part FI are connected to respective input terminals of a ballast circuit BC for generating a high frequency lamp current. A first output terminal of ballast circuit BC supplies a high voltage to a first electrode of the lamp LA and is for that purpose connected to connection terminal 1. A second output terminal of ballast circuit BC supplies a lower voltage to a second electrode of the lamp LA and is connected to connection terminal 2. The first and second electrodes of the lamp are coupled to connection terminal 1 and connection terminal 2 respectively. During operation of the ballast circuit BC a high frequency voltage with a high amplitude is present at connection terminal 1. Since the connection terminal 1 is comparatively close to connection terminals 3 and 4, a parasitic capacitance exists between these connection terminals. This parasitic capacitance is represented by the reference Cp in FIG. 1. DS is a circuit part for generating a further high frequency current with the same frequency as the lamp current but phase shifted with respect to the lamp current. An input terminal of circuit part DS is connected to connection terminal 1. An output terminal of circuit part DS is connected to connection terminal 3.

The operation of the circuit arrangement shown in FIG. 1 is as follows.

When connection terminals 3 and 4 are connected to the poles of a supply voltage source supplying a low frequency AC voltage, such as a 50 Hz or 60 Hz mains supply, the ballast circuit BC generate a high frequency lamp current with frequency f out of said low frequency supply voltage. This current causes an AC voltage with frequency f and a comparatively high amplitude to be present at connection terminal 1. Because of the capacitive coupling (Cp) between connection terminal 1 and connection terminals 3 and 4 a common mode current Icm is induced through connection terminals 3 and 4. Circuit part DS generates a further high frequency current that also has a frequency f but is phase shifted with respect to the high frequency lamp current and thus also with respect to the induced high frequency currents through connection points 3 and 4. The further high frequency current is coupled to connection terminal 3 via the output terminal of circuit part DS and also to connection terminal 4 via capacitor C4. The phase shift and amplitude of the further high frequency are chosen such that the induced current is substantially cancelled by the further high frequency current.

FIG. 2 shows an embodiment of the circuit part DS in more detail. K1 and K2 are input terminals for connection to a supply voltage source supplying a DC voltage Vdc. Input terminals K1 and K2 are connected by means of a series arrangement of ohmic resistors R2 and R5. A common terminal of resistors R2 and R5 is connected to connection terminal 1 via ohmic resistor R1 and is also connected to the base electrode of a PNP transistor Q1. Input terminals K1 and K2 are also connected by means of a series arrangement of ohmic resistor R3, transistor Q1 and ohmic resistor R4. Resistors R3 and R4 are shunted by capacitor C2 and capacitor C3 respectively. A common terminal K3 of transistor Q1 and resistor R4 is connected to connection terminal 3 via a series arrangement of ohmic resistor R11 and capacitor C1.

The operation of the circuit part shown in FIG. 2 is as follows.

During operation a high frequency AC voltage with frequency f and in phase with the high frequency lamp current is present at connection terminal 1. When this high frequency AC voltage is negative, transistor Q1 is rendered conductive and a current flows through resistor R3, transistor Q1 and resistor R4. As a consequence the voltage at terminal K3 is high. When the high frequency AC voltage is positive, transistor Q1 is rendered non-conductive. Since no current flows through resistor R4, the voltage at terminal K3 is low. The voltage at terminal K3 has the same frequency f as the high frequency AC voltage present at connection terminal 1 and the lamp current, but is shifted in phase by substantially 180 degrees. Via resistor R11 and capacitor C1, this voltage at terminal K3 is coupled to connection terminal 3 and via capacitor C4 also to connection terminal 4. Via this coupling the voltage at terminal K3 causes a current with frequency f to flow through connection terminals 3 and 4 that is phase shifted by substantially 180 degrees with respect to the high frequency current induced by parasitic capacitance Cp. As a consequence these two currents substantially cancel each other so that EMI is effectively suppressed.

In FIG. 3 similar reference numerals refer to similar circuit parts and components as in FIG. 1. During operation a high frequency lamp current is supplied to the lamp LA. This high frequency lamp current flows through the conductors connected to connector terminals 1 and 2. This high frequency lamp current causes a high frequency magnetic field to be present in the shaded area A. This high frequency magnetic field is also present in the shaded area B. The high frequency magnetic field in shaded area B causes a high frequency current to flow through connection terminals 3 and 4. This high frequency current is a differential mode current, meaning that the high frequency current through connection terminal 3 flows in a direction that is opposite to the high frequency current flowing through connection terminal 4. This high frequency differential mode current causes disturbance or in other words EMI in the supply voltage source. At this stage it is remarked that a magnetic field is not only present in the shaded area A, but in the complete area enclosed by the conductors carrying the lamp current. However since the shaded area A is closest to the area B, the strength of the magnetic field in area B is mainly determined by the magnetic field in area A. Also outside area B a magnetic field is present. However, this magnetic field is less strong since it is further away from area A.

The circuit arrangement shown in FIG. 4 differs from the one shown in FIG. 3 in the position and length of the conductors between the ballast circuit BC and the connection terminals 1 and 2 and also in the position and length of the conductors between connection terminals 3 and 4 and filter FI. When the circuit arrangement is in operation, the magnetic field in shaded area B (caused by the high frequency lamp current) causes a high frequency differential mode current to flow through connection terminals 3 and 4 in a similar way as described here-above for the circuit arrangement shown in FIG. 3. However in the circuit arrangement shown in FIG. 4, the conductors are so positioned that the conductors between the filter FI and connection terminal 3 and 4 enclose not only shaded area B but also a part of shaded area A, that is labeled C. Since area A is much closer to the conductors carrying the lamp current than area B, the magnetic field caused by the lamp current is much stronger in area A than in area B. The magnetic field in area A has a direction that is perpendicular to area A. The magnetic field in area B is perpendicular to area B (and thus also perpendicular to area A) but in a direction opposite to the direction of the magnetic field in area A. Like the magnetic field in area B, the magnetic field in area C also causes a differential high frequency current through connection terminals 3 and 4. However, since the magnetic fields in area B and area C have opposite directions the high frequency currents induced by these fields are phase shifted with respect to each other by 180 degrees. Although area B is much larger than area C, the magnetic field in area C is much stronger than in area B. Areas B and C can be chosen such that the amplitudes of the induced currents are substantially equal so that these currents cancel each other and disturbance is effectively suppressed. The conductors can be formed by wires but can also be formed by conductive tracks on a printed circuit board. Preferably the conductors between connection terminals 1 and 2 and the ballast circuit BC are formed by means of conductive tracks on one side of he printed circuit board and the conductors between connection terminals 3 and 4 and the filter FI are formed by means of conductive tracks on the opposite side of the printed circuit board. This latter way of forming the conductors offers the advantage of high accuracy and little tolerance.

It is remarked that the problem of EMI is not limited to circuit arrangements comprising a connector. Therefore also the applicability of the present invention is not limited to circuit arrangements comprising a connector.

It is also remarked that magnetic fields are also present outside the shaded areas in FIG. 4, for instance in the area enclosed by the conductors connecting the filter FI with the ballast circuit BC. However, since these areas are at a comparatively large distance from the conductors carrying a high frequency current, the strength of the magnetic field is comparatively small and they hardly cause any current to flow through connection terminals 3 and 4. For this reason, the effect of these magnetic fields can be neglected.

1. Circuit arrangement for supplying a lamp equipped with
input terminals for connection to a supply voltage source supplying a low frequency AC voltage,
a ballast circuit coupled to the input terminals for generating a high frequency lamp current with frequency f out of the low frequency AC voltage and equipped with lamp connection terminals, characterized in that the circuit arrangement further comprises a circuit part DS coupled to the input terminals for generating a further high frequency current with frequency f through the input terminals, that is phase shifted with respect to the high frequency lamp current.

2. Circuit arrangement as claimed in claim 1, wherein the further high frequency current is phase shifted with respect to the high frequency lamp current by half a period.

3. Circuit arrangement as claimed in claim 1, wherein the further high frequency current comprises a common mode current.

4. Circuit arrangement as claimed in claim 3, wherein the circuit part DS comprises a PNP transistor of which a base electrode is coupled to a conductor that during operation carries the lamp current.

5. Circuit arrangement as claimed in claim 1, wherein the further high frequency current comprises a differential mode current.

6. Circuit arrangement as claimed in claim 5, wherein the circuit part DS comprises conductors connected between the input terminals and the ballast circuit and enclosing a first area and conductors connected between the ballast circuit and the lamp connection terminals and enclosing a second area and wherein the first and second area overlap.

7. Circuit arrangement as claimed in claim 6, wherein the ballast circuit comprises a printed circuit board and the conductors comprise tracks of conductive material that during operation are magnetically coupled and are situated on opposing sides of the printed circuit board.
